(19) United States
(12) Patent Application Publication
(10) Pub. No.: US 2012/0051394 A1
(43) Pub. Date: Mar. 1, 2012

(54) TEMPERATURE VARIATION SENSING APPARATUS AND METHOD THEREOF

(75) Inventor: Chu-Li Wang, Taipei City (TW)

(73) Assignee: EMCOM TECHNOLOGY INC., Taipei City (TW)

(21) Appl. No.: 13/089,198

(22) Filed: Apr. 18, 2011

(30) Foreign Application Priority Data
Aug. 30, 2010 (TW) 099129089

(51) Int. Cl. G01K 3/00

(52) U.S. Cl. 374/102; 374/E03.001

(57) ABSTRACT

A temperature variation sensing apparatus and a method thereof are provided. The temperature variation sensing apparatus includes a sensing unit and a control unit. The sensing unit senses a variation in temperature to generate a temperature difference signal, while the control unit executes a program code to determine a non-trigger range based on the ambient temperature. When the level of the temperature difference signal is out of the non-trigger range, the control unit generates a control signal, wherein of the non-trigger range varies with the ambient temperature and forms a first curve. The first curve includes at least one first extreme point; the product of slopes of the first curve on two ends of the first extreme point is negative. Software is utilized to perform temperature compensation. As a result, a better sensitivity curve is obtained and the sensing accuracy is accordingly enhanced.

### BACKGROUND OF THE INVENTION

1. Field of the Invention

The present invention generally relates to a temperature variation sensing apparatus and a method thereof. Particularly, the present invention relates a temperature variation sensing apparatus and a method thereof that utilizes software to perform temperature compensation and accordingly achieve a better sensitivity curve and higher sensing accuracy.

2. Description of the Prior Art

Passive infrared sensors (PIR sensor), based on the pyroelectric effect, sense the variation in temperature from the temperature difference between moving objects and the background environment and thus generate a corresponding electrical signal. The generated electrical signal can be outputted to electrical devices such as lamps, bells or alarms to control the operation of the electrical device.

Since the PIR sensor senses the flow of thermal energy in a passive manner, the temperature variation sensing device using the PIR sensor is readily interfered by environmental factors, resulting in sensing errors. For example, when used in outdoor, the environment conditions such as variations in temperature and climate can greatly affect the temperature variation sensing device by falsely triggering the PIR sensor. In addition, when the ambient temperature reaches a certain temperature (for example, a body temperature), warm air blowing over the PIR sensor is easily recognized as motions of human. Under such circumstances, temperature compensation can be performed to compensate for environmental influences on the temperature variation sensing device.

Temperature compensation is typically accomplished by a temperature compensation circuit consisting of thermistors. The temperature compensation circuit can correspondingly adjust the trigger sensitivity (sensitivity) of the temperature variation sensing device according to the ambient temperature. For example, at higher ambient temperature, the increase in trigger sensitivity is diminished to prevent from recognizing warm air blowing over the sensing device as motions of human. FIG. 1A schematically shows the sensitivity curve of a conventional temperature variation sensing device. As shown in FIG. 1A, when the temperature compensation circuit consisting of thermistors having negative temperature coefficient is utilized, the sensitivity curve shows an increasing tendency at the ambient temperature ranging from 0° C. to 40° C. The slope of the sensitivity curve on the ambient temperature around 40° C. is smaller. That is, the increase in sensitivity is diminished as the ambient temperature is close to 40° C. to prevent the above mentioned sensing error due to high sensitivity.

A practical and desirable solution, however, is to reduce the sensitivity at higher ambient temperature. FIG. 1B shows an ideal sensitivity curve of the temperature variation sensing device. As shown in FIG. 1B, the sensitivity curve shows a decreasing tendency as the ambient temperature is close to 40° C. In other words, ideally, the temperature variation sensing device has a U-shaped sensitivity curve. Due to the restriction to physical properties of elements, the temperature compensation circuit using a single thermistor can only realize an increasing sensitivity curve shown in FIG. 1A or a decreasing sensitivity curve. In order to achieve a U-shaped sensitivity curve similar to that of FIG. 1B, a temperature compensation circuit consisting of thermistor having negative temperature coefficient and thermistor having positive temperature coefficient is required. However, due to the restriction to physical properties of thermistor, such as working curve of thermistor, and the drawback of relatively large deviation, such an temperature compensation circuit still has difficulty in realizing the ideal U-shaped sensitivity curve of FIG. 1B.

### SUMMARY OF THE INVENTION

One object of the present invention is to provide a temperature variation sensing apparatus and a method thereof, so that in comparison with the prior art, a better sensitivity curve and higher sensing accuracy can be achieved.

The temperature variation sensing apparatus of the present invention includes a sensing unit and a control unit. The sensing unit senses a variation in temperature to generate a temperature difference signal, while the control unit executes a program code to determine a non-trigger range based on the ambient temperature. When the level of the temperature difference signal is out of the non-trigger range, the control unit generates a control signal, wherein the non-trigger range varies with the ambient temperature and forms a first curve. The first curve includes a first extreme point, wherein the product of slopes of the first curve on two ends of the first extreme point is negative. The present invention utilizes software to determine the sensitivity at different ambient temperatures. That is, the present invention utilizes the program code to perform temperature compensation on the temperature difference signal generated by the sensing unit, so that a better sensitivity curve is obtained and the sensing accuracy is accordingly enhanced.

The method of sensing temperature for use in the temperature variation sensing apparatus includes the following steps: executing a program code to determine a sensitivity level based on an ambient temperature, wherein the sensitivity level varies with the ambient temperature and forms a second curve, the second curve includes at least one second extreme point, a product of slopes of the second curve on two ends of the second extreme point is negative; adjusting a sensitivity of the temperature variation sensing apparatus based on the sensitivity level; and sensing a variation in temperature by means of the temperature variation sensing apparatus. The method of sensing temperature of the present invention utilizes the program code to determine the sensitivity at different ambient temperatures. That is, the temperature compensation is performed by software, resulting in a better sensitivity curve and higher sensing accuracy.

### BRIEF DESCRIPTION OF THE DRAWINGS

FIG. 1A shows a sensitivity curve of a conventional temperature variation sensing device;

FIG. 1B is an ideal sensitivity curve of a temperature variation sensing apparatus;

FIG. 2A is a block diagram of an embodiment of the temperature variation sensing apparatus;,

FIG. 2B is an embodiment of a sensing unit of the temperature variation sensing apparatus of FIG. 2A;

FIG. 2C is an embodiment of a control unit of the temperature variation sensing apparatus of FIG. 2A;

FIG. 3 shows a curve for non-trigger range of the temperature variation sensing apparatus of FIG. 2B;

FIG. 4A is a flow diagram of an embodiment of the method of sensing temperature;

FIG. 4B shows a sensitivity curve of the method shown in FIG. 4A; and

FIG. 4C is a flow diagram of an embodiment of adjusting the sensitivity in the method of FIG. 4A.

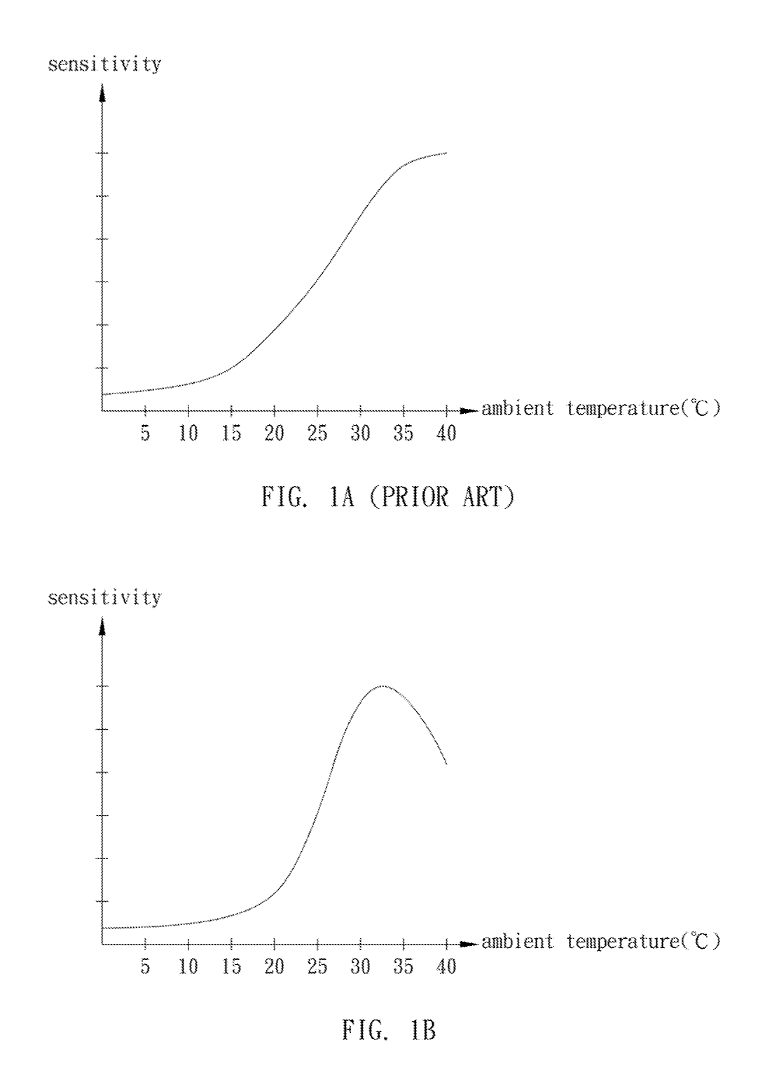

### DETAILED DESCRIPTION OF THE PREFERRED EMBODIMENT

The present invention provides a temperature variation sensing apparatus and a method thereof. In a preferred embodiment, the temperature variation sensing apparatus and the method thereof are applied to PIR-based sensors, such as PIR lights or PIR door bells.

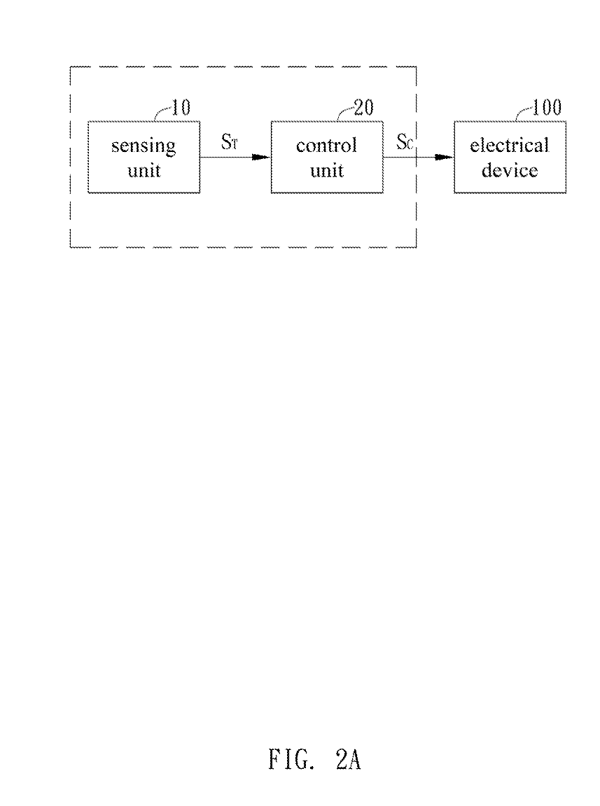

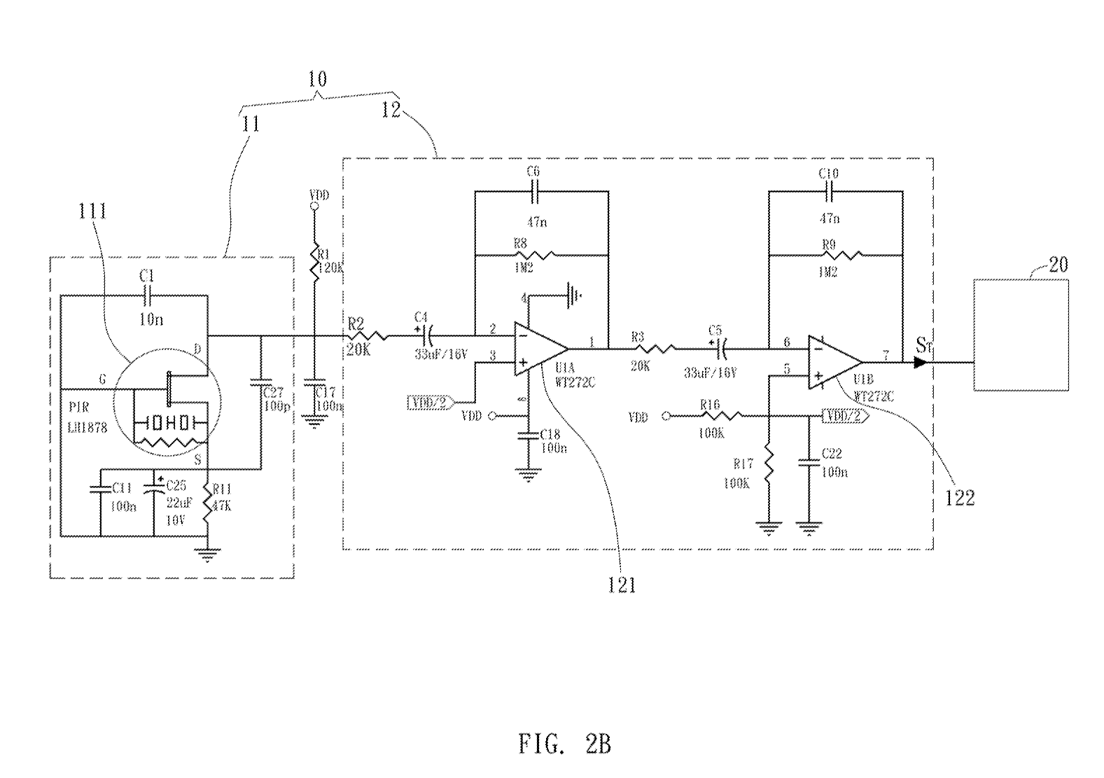

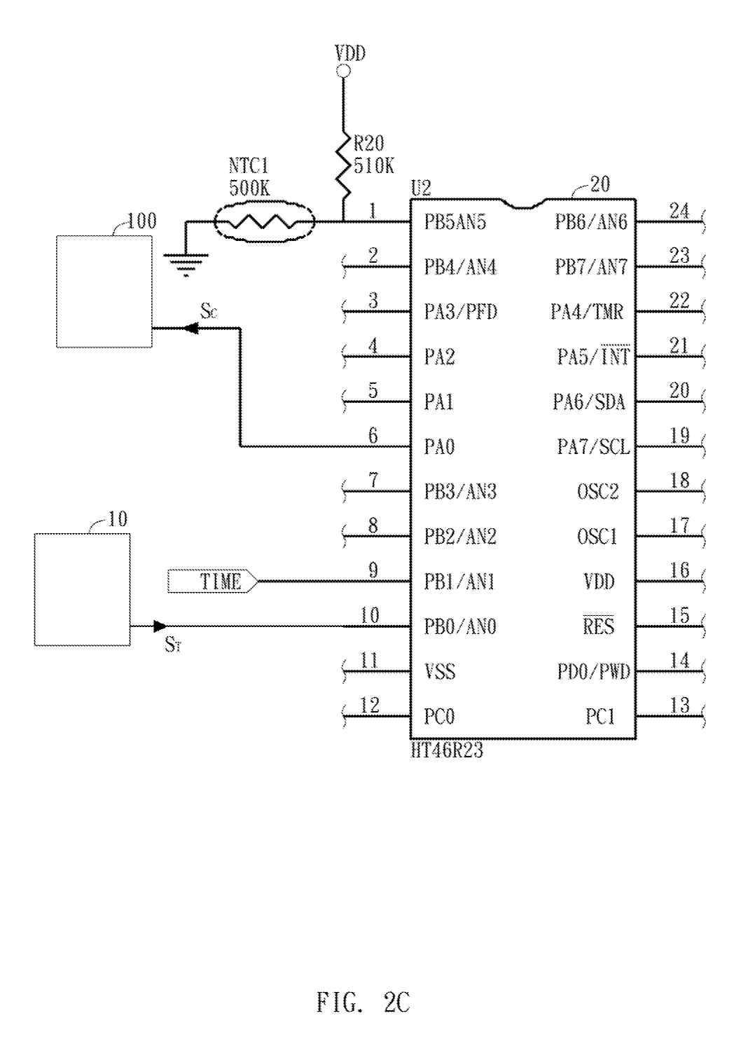

FIG. 2A is a block diagram of an embodiment of a temperature variation sensing apparatus of the present invention. As shown in FIG. 2A, the temperature variation sensing apparatus includes a sensing unit 10 and a control unit 20. The sensing unit 10 senses a variation in temperature to generate a temperature difference signal S_{T}. As the voltage level of the temperature difference signal S_{T} is out of the non-trigger range ΔV (see Table 2), the control unit 20 generates a control signal S_{C} to control the action of an electrical device 100, such as PIR-based sensors including PIR lights, PIR door bells, etc. The value of the non-trigger range ΔV can be a function of the ambient temperature T (see Table 2) and determined by the program code executed by the control unit 20.

FIG. 2B schematically shows an embodiment of the sensing unit of the temperature variation sensing apparatus of FIG. 2A. As shown in FIG. 2B, in this embodiment, the sensing unit 10 includes a sensor circuit 11 and an amplifier circuit 12, wherein the sensor circuit 11 includes a passive infrared sensor 111. The passive infrared sensor 111 senses the motion of a human or heat-radiating object based on the variation in temperature and correspondingly outputs an electrical signal to the amplifier circuit 12. The amplifier circuit 12 includes a first operational amplifier 121 and a second operational amplifier 122, by which the electrical signal of mV range outputted from the passive infrared sensor 111 is amplified by a factor of 1000 to be a temperature difference signal S_{T} that is then outputted to the control unit 20. In the present embodiment, when the sensing unit 10 senses no motion of objects, the amplifier circuit 12 outputs a reference voltage of 2.5 V.

FIG. 2C schematically shows an embodiment of the control unit of the temperature variation sensing apparatus of FIG. 2A. In this embodiment, the control unit 20 is a microcontroller (or Micro Controller Unit, MCU). In other embodiments, however, the control unit 20 can be any device capable of executing the program code, such as computer. Table 1 shows the voltage V_{NTC1} (V) at different ambient temperature T(° C.). The program code executed by the control unit 20 determines the ambient temperature T from the voltage V_{NTC1} inputted at the terminal 1 of the control unit 20. For example, the ambient temperatures T and corresponding voltages V_{NTC1} in Table 1 are stored in an array of the program code. When the voltage V_{NTC1} is between 2.15 V and 2.34 V, it can be determined from the table that the ambient temperature T is between 25° C. and 27.5° C. In the present embodiment, the power supply VDD supplies a voltage of 5V to the thermistor NTC1 and the voltage divider resistor R20 of 510KΩ, wherein the partial voltage at the thermistor NTC1 is the voltage V_{NTC1} inputted at terminal 1 of the control unit 20. In the present embodiment, as shown in Table 1, the ambient temperature T is incremented by 2.5° C. Moreover, for each increment of the ambient temperature T, a buffer voltage of about 0.03 V exits between corresponding voltages V_{NTC1}. However, in other embodiments, the ambient temperature T can be incremented by any suitable value, and the buffer voltage can be adjusted as appropriate. Moreover, the association of the ambient temperature T and voltage V_{NTC1} can be adjusted according to the values of the thermistor NTC1, the voltage divider resistor R20, and the power supply VDD.

TABLE 1

| T (° C.) | V_{NTC1} (V) |
|---|---|
| below 0 | 3.90-5.00 |
| 0.0-2.5 | 3.76-3.93 |
| 2.5-5.0 | 3.62-3.79 |
| 5.0-7.5 | 3.47-3.65 |
| 7.5-10.0 | 3.31-3.50 |
| 10.0-12.5 | 3.14-3.34 |
| 12.5-15.0 | 2.98-3.17 |
| 15.0-17.5 | 2.81-3.01 |
| 17.5-20.0 | 2.64-2.84 |
| 20.0-22.5 | 2.48-2.67 |
| 22.5-25.0 | 2.31-2.51 |
| 25.0-27.5 | 2.15-2.34 |
| 27.5-30.0 | 2.00-2.18 |
| 30.0-32.5 | 1.85-2.03 |
| 32.5-35.0 | 1.71-1.88 |
| 35.0-37.5 | 1.58-1.74 |
| 37.5-40.0 | 1.45-1.61 |
| over 40 | 0.00-1.48 |

Table 2 shows the association of the ambient temperature T and the non-trigger range ΔV, wherein each increment of the ambient temperature T corresponds to one non-trigger range ΔV with respective lower limit voltage V_{L} and upper limit voltage V_{H}. The temperature difference signal S_{T} generated by the sensing unit 10 is inputted at the terminal 10 of the control unit 20. When the program code executed by the control unit 20 determines that the voltage of the temperature difference signal S_{T} is out of the voltage range corresponding to the non-trigger range ΔV, the control unit 20 generates the control signal S_{C} and outputs the control signal S_{C} from the terminal 6 of the control unit 20 to the electrical device 100. For example, for the ambient temperature T between 25° C. and 27.5° C., the non-trigger range ΔV is ±0.8, so that the lower limit voltage V_{L} is 1.7V by subtracting the non-trigger range ΔV (0.8V) from the reference voltage of 2.5 V (i.e. 2.5V−0.8 V=1.7 V), and the upper limit voltage V_{H} is 3.3V by adding the non-trigger range ΔV (0.8V) into the reference voltage of 2.5V (i.e. 2.5 V+0.8 V=3.3 V). Therefore, when the ambient temperature T is between 25° C. and 27.5° C. (V_{NTC1}=2.15 to 2.34 V), the control unit 20 will generate the control signal S_{C} only if the program code executed by the control unit 20 determines that the voltage of the temperature difference signal S_{T} sent from the sensing unit 10 to the control unit 20 is lower than the lower limit voltage V_{L} or higher than the upper limit voltage V_{H}. For example, the ambient temperatures T and corresponding non-trigger ranges ΔV in Table 2 are stored in an array of the program code. It is determined from the table that when the ambient temperature T is between 25° C. and 27.5° C., the control unit 20 will generate the control signal S_{C} only if the voltage of the temperature difference signal S_{T} is lower than 1.7 V or higher than 3.3 V.

TABLE 2

| T (° C.) | V_{L} (V) | V_{H} (V) | ΔV |
|---|---|---|---|
| below 0 | 1.82 | 3.18 | ±0.68 |
| 0.0-2.5 | 1.80 | 3.20 | ±0.70 |
| 2.5-5.0 | 1.70 | 3.30 | ±0.80 |
| 5.0-7.5 | 1.60 | 3.40 | ±0.90 |
| 7.5-10.0 | 1.49 | 3.51 | ±1.01 |
| 10.0-12.5 | 1.38 | 3.62 | ±1.12 |
| 12.5-15.0 | 1.26 | 3.74 | ±1.24 |
| 15.0-17.5 | 1.17 | 3.83 | ±1.33 |
| 17.5-20.0 | 1.27 | 3.73 | ±1.23 |
| 20.0-22.5 | 1.41 | 3.59 | ±1.09 |
| 22.5-25.0 | 1.55 | 3.45 | ±0.95 |
| 25.0-27.5 | 1.70 | 3.30 | ±0.80 |
| 27.5-30.0 | 1.82 | 3.18 | ±0.68 |
| 30.0-32.5 | 1.94 | 3.06 | ±0.56 |
| 32.5-35.0 | 2.06 | 2.94 | ±0.44 |
| 35.0-37.5 | 1.98 | 3.02 | ±0.52 |
| 37.5-40.0 | 1.90 | 3.10 | ±0.60 |
| over 40 | 1.82 | 3.18 | ±0.68 |

When the non-trigger range ΔV is smaller, the possibility of the voltage value of the temperature difference signal ST falls out of the non-trigger range ΔV is relatively larger, increasing the chance of generating the control signal S_{C} by the control unit 20 and in turn increasing the sensitivity. In contrast, when the non-trigger range ΔV is larger, the possibility of the voltage value of the temperature difference signal S_{T} falls out of the non-trigger range ΔV is relatively smaller, decreasing the chance of generating the control signal S_{C} by the control unit 20 and in turn reducing the sensitivity. In other words, the value of the non-trigger range ΔV is inversely proportional to the sensitivity of the temperature variation sensing apparatus.

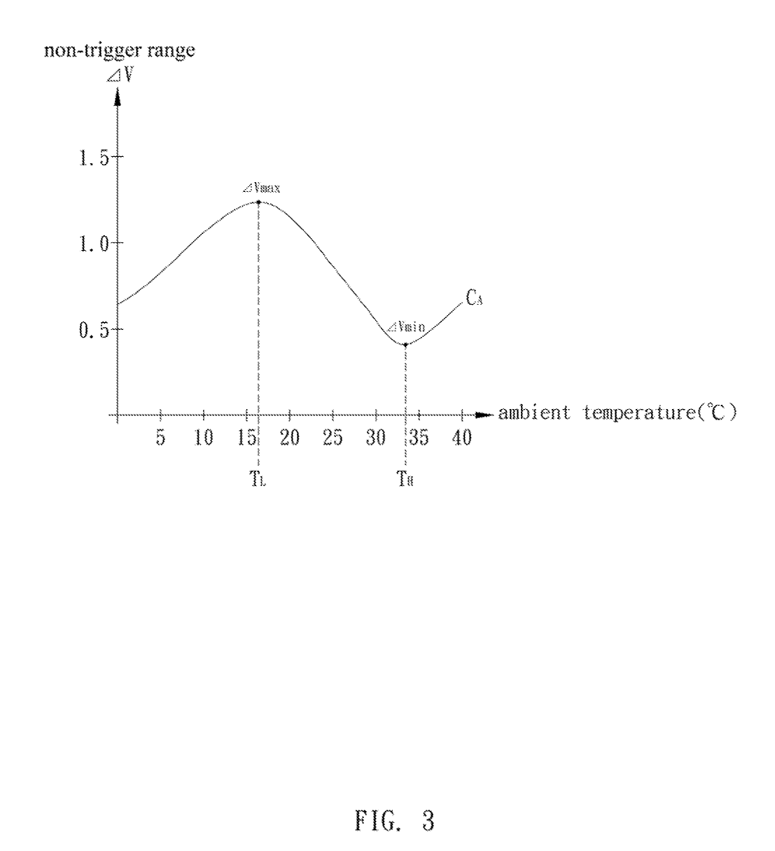

FIG. 3 schematically illustrates a curve for the non-trigger range of the temperature variation sensing apparatus of FIG. 2B. As shown in FIG. 3, the non-trigger range ΔV varies with the ambient temperature T and forms a first curve C_{A}. In the present embodiment, the first curve C_{A} includes a minimum ΔVₘᵢₙ and a maximum ΔVₘₐₓ. The minimum ΔVₘᵢₙ is the absolute minimum of the first curve C_{A}. The product of slopes of the first curve C_{A} on two ends of the minimum ΔVₘᵢₙ is negative, so that the portion of the first curve C_{A} that corresponds to the minimum ΔVₘᵢₙ is an upward U curve. In this case, the minimum ΔVₘᵢₙ corresponds to a high-limit temperature T_{H}. When the ambient temperature T is close to the high-limit temperature T_{H}, the controller unit 20 increases the non-trigger range ΔV as the ambient temperature T increases or decreases. That is, the trigger sensitivity of the temperature variation sensing apparatus is reduced so that the misjudgment of warm air blowing over as motion of human can be prevented at high ambient temperature T. Preferably, the high-limit temperature T_{H} is between 31° C. and 36° C. (in this embodiment, between 32.5° C. and 35° C.). However, in other embodiments, the high-limit temperature T_{H} may have other values.

The maximum ΔVₘₐₓ is the absolute maximum of the first curve C_{A}. The product of slopes of the first curve C_{A} on two ends of the maximum ΔVₘₐₓ is negative, so that the portion of the first corner C_{A} that corresponds to the maximum ΔVₘₐₓ is a downward U curve. In this case, the maximum ΔVₘₐₓ corresponds to a low-limit temperature T_{L}. When the ambient temperature T is close to the low-limit temperature T_{L}, the control unit 20 reduces the non-trigger range ΔV as the ambient temperature T increases or decreases. That is, the trigger sensitivity of the temperature variation sensing apparatus is increased so that the sensing accuracy of the motion of people wearing heavy clothes can be enhanced at low ambient temperature T. Preferably, the low-limit temperature T_{L} is between 15° C. and 20° C. (in this embodiment, between 15° C. and 17.5° C.). In other embodiments, however, the low-limit temperature T_{L} may have other values.

Moreover, in other embodiments, the first curve C_{A} can includes only the minimum ΔVₘᵢₙ or the maximum ΔVₘₐₓ. That is, the non-trigger range ΔV increases when the ambient temperature T is close to the low-limit temperature T_{L}. Alternatively, the non-trigger range ΔV reduces when the ambient temperature T is close to the high-limit temperature T_{H}. In such cases, the association of the ambient temperature T and the non-trigger range ΔV in Table 2 is adjusted accordingly.

In the temperature variation sensing apparatus of the present invention, the sensitivity is adjusted by a program code for different ambient temperatures. That is, the temperature difference signal S_{T} generated by the sensing unit 10 is compensated by means of software. In comparison with the prior art of using thermistor for temperature compensation, the temperature variation sensing apparatus of the present invention can realize a substantial ideal sensitivity curve and enhance the sensing accuracy.

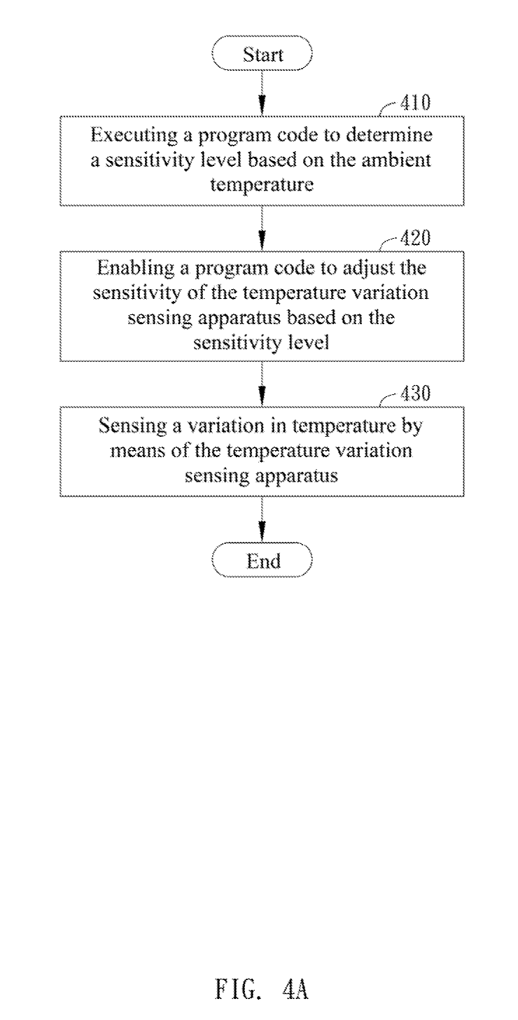

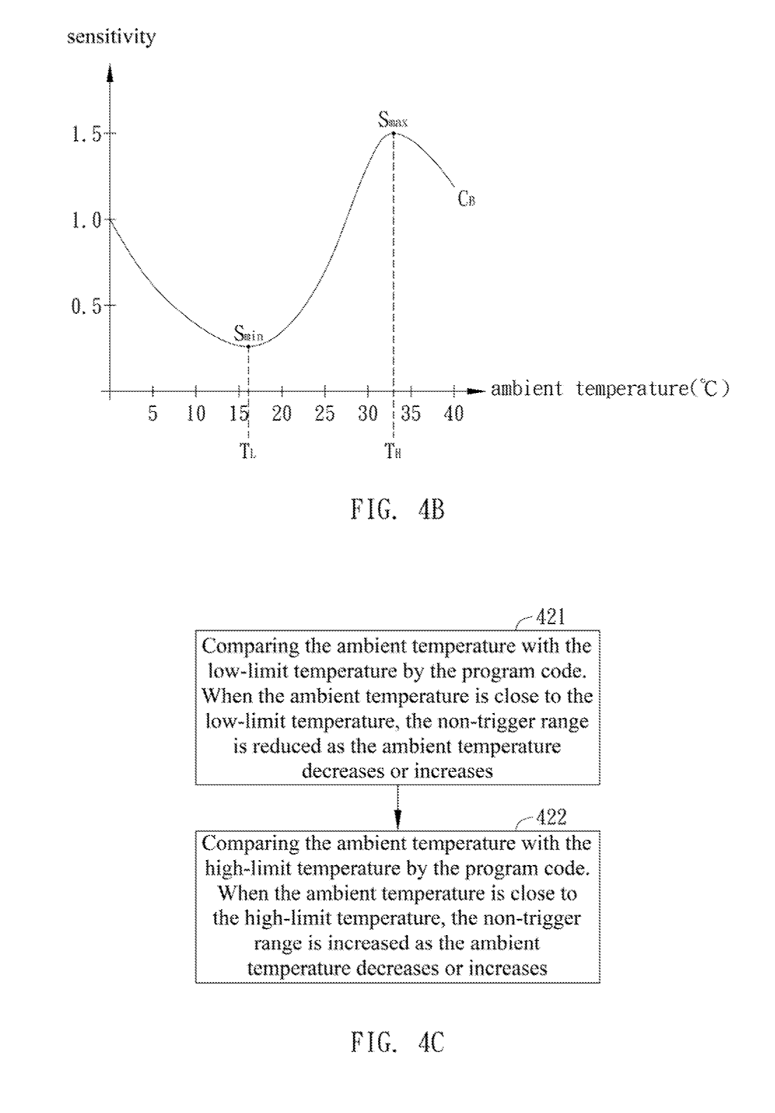

FIG. 4A is a flow diagram of an embodiment of a method for sensing temperature. In the present embodiment, the method is provided for use in a temperature variation sensing apparatus with a sensing unit and a control unit. The sensing unit senses the variation in temperature to generate a temperature difference signal. The control unit executes a program code to determine a non-trigger range based on the ambient temperature. As the voltage level of the temperature difference signal is out of the non-trigger range, which is inversely proportional to the sensitivity, the control unit generates a control signal for controlling an electrical device connected to the temperature variation sensing apparatus. As shown in FIG. 4A, step 410 includes executing a program code to determine a sensitivity level based on the ambient temperature. As shown in FIG. 4B, the sensitivity level varies with the ambient temperature T and forms a second curve C_{B}. In the present embodiment, the second curve C_{B} includes a minimum Sₘᵢₙ and a maximum Sₘₐₓ. As described above, the sensitivity is inversely proportional to the value of the non-trigger range, so that the second curve C_{B} exhibits an opposite tendency with respect to the first curve C_{A} of FIG. 3. The minimum Sₘᵢₙ is the absolute minimum of the second curve C_{B}. The product of slopes of the second curve C_{B} on both ends of the minimum Sₘᵢₙ is negative, so that the portion of the second curve C_{B} that corresponds to the minimum Sₘᵢₙ is an upward U curve. In this case, the minimum Sₘᵢₙ a low-limit temperature T_{L}. When the ambient temperature T is close to the low-limit temperature T_{L}, the control unit increases the trigger sensitivity of the temperature variation sensing apparatus so that the sensing accuracy of the motion of people wearing heavy clothes can be enhanced at low ambient temperature T. The maximum Sₘₐₓ is the absolute maximum of the second curve C_{B}. The product of slopes of the second curve C_{B} on two ends of the maximum Sₘₐₓ is negative, so that the portion of the second curve C_{B} that corresponds to the maximum Sₘₐₓ is a downward U curve. In this case, the maximum Sₘₐₓ corresponds to a high-limit temperature T_{H}. When the ambient temperature T is close to the high-limit temperature T_{H}, the control unit reduces the trigger sensitivity of the temperature variation sensing apparatus so that the misjudgment of warm air blowing over as motion of human can be prevented at high ambient temperature T.

Step 420 includes enabling a program code to adjust the sensitivity of the temperature variation sensing apparatus based on the sensitivity level. In a preferred embodiment, as shown in FIG. 4c, the step 420 in FIG. 4A includes step 421 of comparing the ambient temperature with the low-limit temperature by the program code. When the ambient temperature is close to the low-limit temperature, the non-trigger range is reduced as the ambient temperature decreases or increases. In the present embodiment, the low-limit temperature is between 15° C. and 20° C. In other embodiments, however, the low-limit temperature may have other values. Step 422 includes comparing the ambient temperature with the high-limit temperature by the program code. When the ambient temperature is close to the high-limit temperature, the non-trigger range is increased as the ambient temperature decreases or increases. In the present embodiment, the high-limit temperature is between 31° C. and 36° C. In other embodiments, however, the high-limit temperature may have other values. In other embodiments, however, the step 420 can include only either step 421 or step 422.

Step 430 includes sensing a variation in temperature by means of the temperature variation sensing apparatus. At this point, the temperature compensation of the temperature variation sensing apparatus has been performed to achieve a higher sensing accuracy.

In the present invention, the method of sensing temperature utilizes a program code to determine the sensitivity at different ambient temperature. That is, the temperature compensation is performed by means of software. In comparison with the prior art of using thermistor for temperature compensation, the method of the present invention can realize a substantial ideal sensitivity curve and enhance the sensing accuracy.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A temperature variation sensing apparatus, comprising:
a sensing unit for sensing a variation in temperature to generate a temperature difference signal; and
a control unit for executing a program code to determine a non-trigger range based on an ambient temperature, wherein the control unit generates a control signal as a level of the temperature difference signal is out of the non-trigger range, the non-trigger range varies with the ambient temperature and forms a first curve, the first curve includes at least one first extreme point, a product of slopes of the first curve on two ends of the first extreme point is negative.

2. The temperature variation sensing apparatus of claim 1, wherein the first extreme point is a maximum and corresponds to a low-limit temperature, so that when the ambient temperature is lower than the low-limit temperature, the non-trigger range reduces as the ambient temperature decreases, and when the ambient temperature is higher than the low-limit temperature, the non-trigger range reduces as the ambient temperature increases.

3. The temperature variation sensing apparatus of claim 2, wherein the low-limit temperature is substantially between 15° C. and 20° C.

4. The temperature variation sensing apparatus of claim 1, wherein the first extreme point is a minimum and corresponds to a high-limit temperature, so that when the ambient temperature is lower than the high-limit temperature, the non-trigger range increases as the ambient temperature decreases, and when the ambient temperature is higher than the high-limit temperature, the non-trigger range increases as the ambient temperature increases.

5. The temperature variation sensing apparatus of claim 4, wherein, the high-limit temperature is substantially between 31° C. and 36° C.

6. A method of sensing temperature for use in a temperature variation apparatus, comprising the following steps:
executing a program code to determine a sensitivity level based on an ambient temperature, wherein the sensitivity level varies with the ambient temperature and forms a second curve, the second curve includes at least one second extreme point, a product of slopes of the second curve on two ends of the second extreme point is negative;
enabling the program code to adjust a sensitivity of the temperature variation sensing apparatus based on the sensitivity level; and
sensing a variation in temperature by means of the temperature variation sensing apparatus.

7. The method of sensing temperature of claim 6, wherein the second extreme point is a minimum and corresponds to a low-limit temperature, and the temperature variation sensing apparatus comprises a sensing unit and a control unit, the sensing unit senses the variation in temperature to generate a temperature difference signal, the control unit executes the program code and generates a control signal as a level of the temperature difference signal is out of a non-trigger range, the non-trigger range is inversely proportional to the sensitivity, and wherein the step of adjusting the sensitivity of the temperature variation sensing apparatus comprises:
comparing the ambient temperature with the low-limit temperature;
when the ambient temperature is lower than the low-limit temperature, reducing the non-trigger range as the ambient temperature decreases; and
when the ambient temperature is higher than the low-limit temperature, reducing the non-trigger range as the ambient temperature increases.

8. The method of sensing temperature of claim 7, wherein the low-limit temperature is substantially between 15° C. and 20° C.

9. The method of sensing temperature of claim 6, wherein the second extreme point is a maximum and corresponds to a high-limit temperature, and the temperature variation sensing apparatus comprises a sensing unit and a control unit, the sensing unit senses the variation in temperature to generate a temperature difference signal, the control unit executes the program code and generates a control signal as a level of the temperature difference signal is out of a non-trigger range, the non-trigger range is inversely proportional to the sensitivity, wherein the step of adjusting the sensitivity of the temperature variation sensing apparatus comprises:
comparing the ambient temperature with the high-limit temperature;
when the ambient temperature is lower than the high-limit temperature, increasing the non-trigger range as the ambient temperature decreases; and
when the ambient temperature is higher than the high-limit temperature, increasing the non-trigger range as the ambient temperature increases.

10. The method of sensing temperature of claim 9, wherein the high-limit temperature is substantially between 31° C. and 36° C.
